(19) United States
(12) Patent Application Publication
(10) Pub. No.: US 2025/0353445 A1
(43) Pub. Date: Nov. 20, 2025

(54) ADJUSTABLE HITCH RISER ASSEMBLY AND A FASTENING SYSTEM

(71) Applicant: David Stanley Steele, Shannon Brook (AU)

(72) Inventor: David Stanley Steele, Shannon Brook (AU)

(21) Appl. No.: 19/208,554

(22) Filed: May 14, 2025

(30) Foreign Application Priority Data
May 15, 2024 (AU) 2024901420
May 15, 2024 (AU) 2024901423

(51) Int. Cl. B60R 9/06; B60R 9/10

(52) U.S. Cl. CPC B60R 9/06; B60R 9/10

(57) ABSTRACT

The present invention relates to an adjustable hitch riser assembly and/or a fastener system. The adjustable hitch riser assembly comprises an attachment member that is adapted to be movable relative to the hitch receiver member to allow a height of the attachment member to be adjusted. The fastener system comprises a peg receiving member, a handle member pivotably connected to the peg receiving member, and a third member pivotably or rotational connected to the second arm. The third arm is adapted to releasably secure to a base or structure. The present fastener system alleviates some of the issues associated with presently available tie down systems.

### RELATED APPLICATIONS

This application claims priority of Australian Patent Application No. 2024901420, filed May 15, 2024, and Australian Patent Application No. 2024901423, filed May 15, 2024, each of which is hereby incorporated herein by reference in its entirety.

### TECHNICAL FIELD

The present invention relates to the field of storage and transport. Particularly, the present invention relates to a hitch riser and/or a fastening assembly. More particularly, the present invention relates to a height adjustable hitch riser assembly, and/or a fastening assembly for motorcycle and/or bicycles and the like.

### BACKGROUND

Any references to methods, apparatus or documents of the prior art are not to be taken as constituting any evidence or admission that they formed, or form part of the common general knowledge.

Hitch risers are utilized to raise the hitch receiver of vehicles, campers, or caravans to accommodate different towing heights or to provide clearance for accessories such as bike carriers, cargo carriers, and the like. However, existing hitch risers in the market have limitations concerning adjustability, universality, and durability.

Existing hitch risers typically offer fixed height settings, restricting their adaptability to different towing scenarios. Moreover, they often lack compatibility with a wide range of attachments, necessitating the purchase of multiple specialized accessories for different purposes. Additionally, prior art hitch risers may suffer from structural issues such as fatigue, cracking, or bending due to suboptimal materials and design.

Furthermore, conventional hitch risers fail to provide a seamless and integrated solution for users, often protruding conspicuously from the vehicle's rear and adding unwanted bulk and weight.

Additionally, transport of motorcycles and/or bicycles typically require securing assemblies of systems. Prior art systems for securing motorcycles and/or bicycles typically utilize straps over the handles. This can cause stress on the fork, frame and/or suspension of the bicycle and/or motorcycle. Alternatively, turn buckles can be utilized with the pegs/pedals of the motocycle and/or bicycle; however, these can cause fatigue and require regular maintenance and checks during use.

Another problem with utilizing these techniques is that the straps are susceptible to fraying, and the turn buckles are susceptible to unrattling and coming loose during use. It will be appreciated that failure of these prior art solutions can be very expensive and time consuming to resolve.

It would be advantageous to address one or more of the above issues and/or to provide the consumer with a commercial alternative to the presently available solutions.

### SUMMARY OF INVENTION

In an aspect, the invention provides an adjustable hitch riser, the height adjustable hitch riser comprising:
a hitch receiver member for connecting to a hitch receiver;
an attachment member connected to the hitch receiver member, the attachment member being adapted to be movable relative to the hitch receiver member to allow a height of the attachment member to be adjusted.

Preferably, the attachment member is movable in a vertical direction relative to the hitch receiver member.

Preferably, the adjustable hitch receiver comprises a first pair of adjustable arms and a second pair of adjustable arms connecting the attachment member to the hitch receiver member. Preferably, the first pair of adjustable arms and the second pair of adjustable arms are configured to rotate relative to the hitch receiver member to thereby move the attachment member. Preferably, the first pair of adjustable arms and the second pair of adjustable arms are angularly adjustable relative to the hitch receiver member to thereby adjust a position of the attachment member. Preferably, the first pair of adjustable arms and the second pair of adjustable arms are substantially parallel.

Preferably, the attachment member is pivotably or rotationally connected to the first pair of adjustable arms. Preferably, the first pair of adjustable arms includes three pairs of apertures for connecting the first pair of adjustable arms to the hitch receiver member and the attachment member. Preferably, the three pairs of apertures are axially aligned apertures for connecting the first pair of adjustable arms to the hitch receiver member and the attachment member. Preferably, the second pair of adjustable arms includes two pairs of apertures for connecting the second pair of adjustable arms to the hitch receiver member and the attachment member. Preferably, the two pairs of apertures are axially aligned apertures for connecting the second pair of adjustable arms to the hitch receiver member and the attachment member.

Preferably, the first pair of adjustable arms is connected at a first position to the hitch receiver member. Preferably, the first pair of adjustable arms is fixedly connected at a first position to the hitch receiver member. Preferably, the first pair of adjustable arms is connected to the hitch receiver member through a first pair of axially aligned apertures.

Preferably, the first pair of adjustable arms is connected at a second position to the attachment member. Preferably, the first pair of adjustable arms is fixedly connected at a second position to the attachment member. Preferably, the first pair of adjustable arms is connected to the hitch receiver member through a second pair of axially aligned apertures.

Preferably, the first pair of adjustable arms is releasably connected to the attachment member between at least the first position and the second position.

Preferably, the attachment member comprises an elongate member connected to an arcuate member. Preferably, the attachment member includes a plurality of axially aligned pairs of apertures for receiving a bolt or securing means therethrough to releasably connect the attachment member to the first pair of adjustable arms. Preferably, the attachment member is adapted to align the axially aligned pairs of apertures with a third pair of axially aligned apertures of the first adjustable arm to allow a securing device to secure the attachment member in place.

In an aspect, the invention provides a fastening system comprising:
a peg receiving member having at least one first arm;
a handle member pivotably or rotationally connected to the peg receiving member, the handle member comprising at least one second arm pivotably or rotationally connected to the at least one first arm; and
a third member pivotably or rotational connected to the second arm, wherein the third member is adapted to releasably secure to a base.

Preferably, the peg receiving member comprises a body.

Preferably, the body comprises an aperture or bore therethrough for receiving a peg of a bicycle.

Preferably, the body is or comprises a square hollow section or a rectangular hollow section.

Preferably, at least one first arm is affixed and/or secured to the body.

Preferably, the peg receiving member comprises a pair of first arms.

Preferably, the pair of first arms are spaced apart.

Preferably, each first arm comprises an aperture at a distal end thereof.

Preferably, the peg receiving member further comprises a securing tab.

Preferably, the securing tab comprises an aperture.

Preferably, the body comprises a pair of aligned apertures adapted to retain a securing device therethrough.

Preferably, the handle member comprises a pivotable section.

Preferably, the pivotable section comprises or is the second arm.

Preferably, the second arm comprises a first aperture spaced apart from a second aperture. Preferably, first aperture is adapted to pivotably or rotationally connected to the third member. Preferably, the second aperture is adapted to pivotably or rotational connect to a respective first arm.

Preferably, a handle is suitably connected to the pivotable section by an elongate portion.

Preferably, the elongate portion comprises an aperture adapted to receive a securing device. The aperture of the elongate portion is alignable with the aperture of the securing tab.

Preferably, the third member comprises a first aperture that is spaced apart from the third aperture.

Preferably, the fastening system further comprises a base.

Preferably, the base comprises a plate.

Preferably, the plate comprises a first set of apertures adapted to fasten to a desired surface.

Preferably, the plate comprises a second set of apertures adapted to receive fastener or link to connect to the second aperture of the third member.

Preferably, the fastening system further comprises a length of chain connecting the base to the third member.

Preferably, the fastening system further comprises one or more securing devices.

Preferably, the fastening system further comprises a first securing device adapted to secure the peg to the peg receiving member.

Preferably, the fastening system further comprises a second securing device adapted to retain the orientation of the handle member to the peg receiving portion.

Preferably, when the handle is lifted, the third arm is pulled towards the peg receiving member.

The fastening system for use in securing a bicycle or motorcycle. The fastening system when used in securing a bicycle or motorcycle.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a perspective view of an embodiment of an adjustable hitch riser assembly according to an embodiment of the present invention;

FIG. 2 shows an embodiment of a first arm;

FIG. 3 shows an embodiment of a second arm;

FIG. 4 shows an embodiment of the hitch receiver member;

FIG. 5 shows an embodiment of the attachment member;

FIG. 6 shows a perspective view of an embodiment of an adjustable hitcher riser assembly;

FIG. 7 shows an embodiment of a cover;

FIG. 8 shows an embodiment of a strengthening member;

FIG. 9 shows another embodiment of a strengthening member;

FIGS. 10 to 14 show different configurations of the adjustable hitch riser assembly;

FIG. 15 shows a perspective of an embodiment of the fastening system according to the present invention;

FIG. 16 shows another perspective of the embodiment of the fastening system according to FIG. 15;

FIG. 17 shows an embodiment of the first arm of the fastening system of FIG. 15;

FIG. 18 shows an embodiment of a tab of the fastening system;

FIG. 19 shows an embodiment of a handle member of the fastening system;

FIG. 20 shows an embodiment of the third member of the fastening system;

FIG. 21 shows an embodiment of the base of the fastening system; and

FIG. 22 shows the fastening system retaining a bicycle.

### DETAILED DESCRIPTION OF PREFERRED EMBODIMENTS

As used herein, the term ‘integrally formed’ means formed of a uniform material. In this regard, ‘integrally formed’ means that the member or feature is formed from a single material or a unitary piece of material.

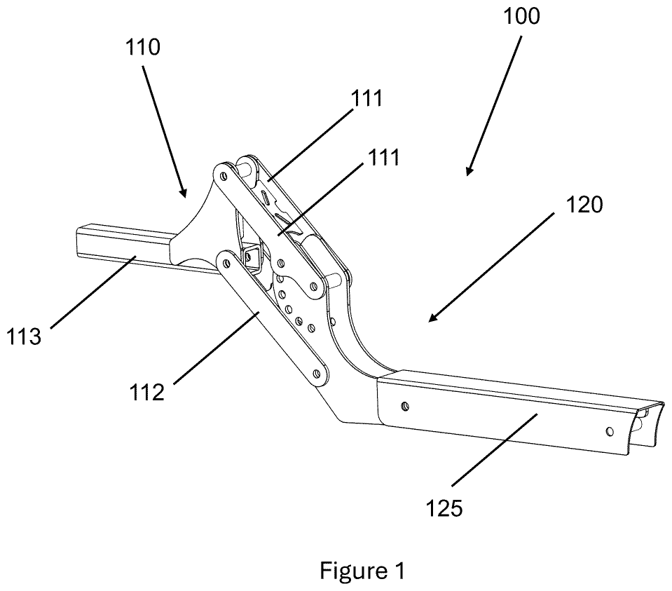

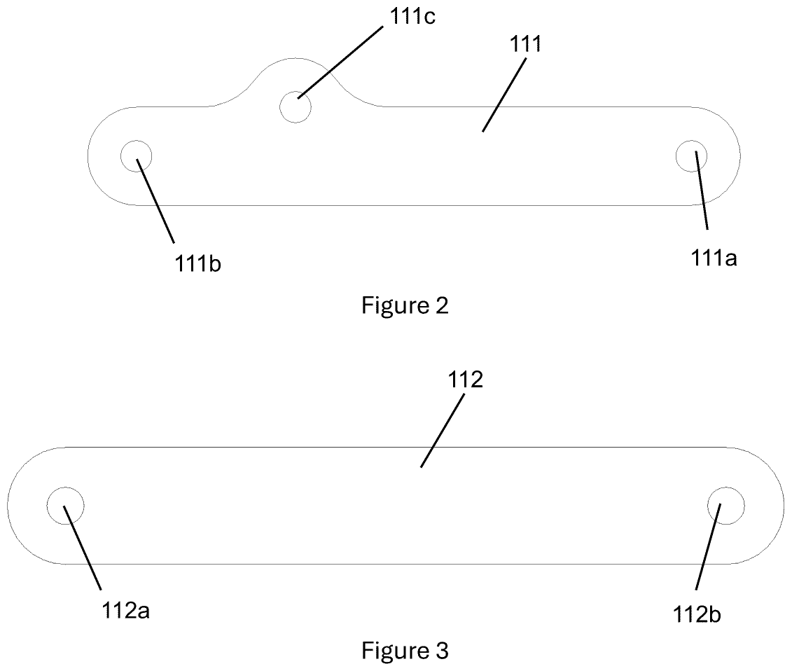

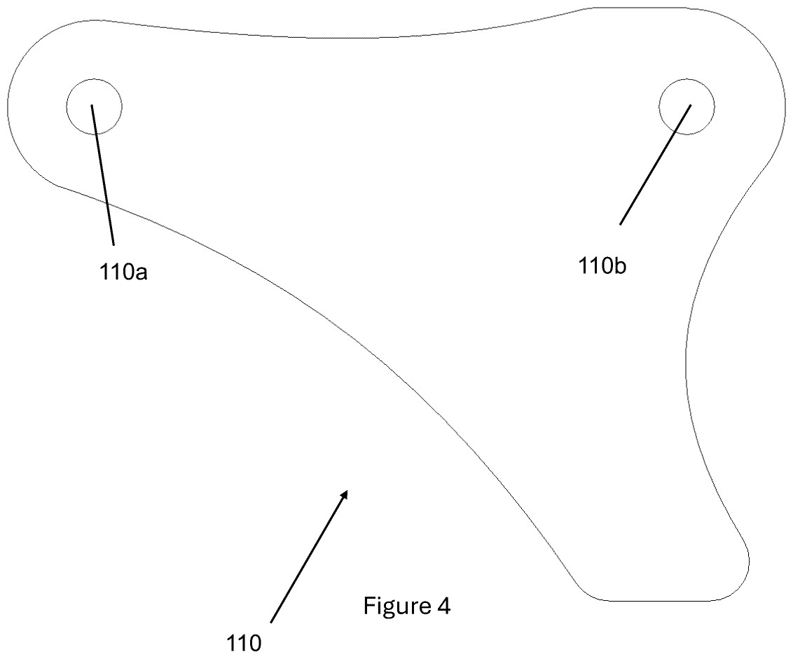

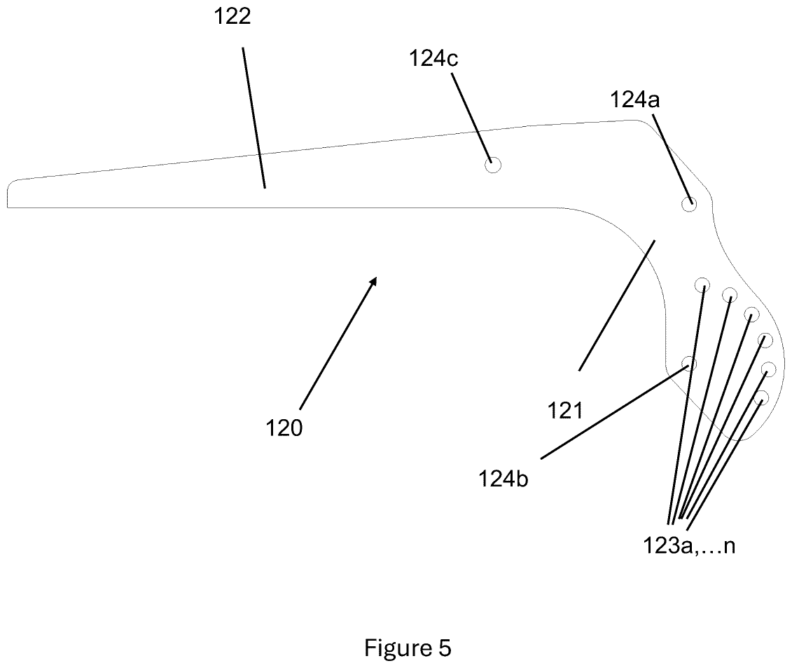

Shown in FIG. 1 is a perspective view of an embodiment of the adjustable hitcher riser assembly. The present invention relates to an adjustable hitch riser assembly for connecting a hitch receiver to an attachment member. The adjustable hitch riser assembly (100) comprises a hitch receiver member (110) for connecting to a hitch receiver and an attachment member (120) connected to the hitch receiver member (110). The hitch receiver member (110) is adapted to be removably secured to a hitch receiver. The person skilled in the art will appreciate that many different methods and means can be utilized to secure the hitch receiver.

The attachment member (120) is adapted to be movable relative to the hitch receiver member (110) to allow a height of the attachment member (120) to be adjusted.

The attachment member (120) may be movable in a vertical direction relative to the hitch receiver member (110). This allows for the height of the attachment member (120) to be adjusted to accommodate different sizes of hitch receivers and attachment members.

The adjustable hitch riser (100) includes a first pair of adjustable arms (111) and a second pair of adjustable arms (112) connecting the attachment member (120) to the hitch receiver member (110). The first pair of adjustable arms (111) and the second pair of adjustable arms (112) are configured to rotate relative to the hitch receiver member (110) to thereby move the attachment member (120). As such, the first pair of adjustable arms (111) and the second pair of adjustable arms (112) may be angularly adjustable relative to the hitch receiver member (110) to thereby adjust a position of the attachment member (120). The first pair of adjustable arms (111) and the second pair of adjustable arms (112) may be substantially parallel to each other and remain parallel when pivoting or rotating relative to the hitch receiver member (110).

The attachment member (120) may be pivotably or rotationally connected to the first pair of adjustable arms (111). The first pair of adjustable arms (111) may include three pairs of axially aligned apertures (111a, 111b, 111c) for connecting the first pair of adjustable arms (111) to the hitch receiver member (110) and the attachment member (120). In an embodiment, the aperture (111a) is located at or adjacent a first end of the adjustable arm (111). In embodiments, the apertures (111b) is located at or adjacent an opposing end of the adjustable arm (111), relative to the first end. In an embodiment, the aperture (111c) is in line with the apertures (111a and 111b). In one embodiment, the adjustable arm comprises a tab having the aperture (111c). The second pair of adjustable arms (112) may include two pairs of axially aligned apertures (112a, 112b) for connecting the second pair of adjustable arms (112) to the hitch receiver member (110) and the attachment member (120). In one embodiment, aperture (112a) is located at or adjacent a first end of a first end of adjustable arm (112). In embodiments, aperture (112b) is located at or adjacent an opposing end of the adjustable arm (112), relative to the first end.

The first pair of adjustable arms (111) may be connected at a first position to the hitch receiver member (110). The first pair of adjustable arms (111) may be fixedly pivotably or rotationally connected at a first position to the hitch receiver member (110) through a first pair of axially aligned apertures (110a). The first pair of adjustable arms (111) may be connected at a second position to the attachment member (120). The first pair of adjustable arms (111) may be fixedly pivotably or rotationally connected at a second position to the attachment member (120) through a first pair of axially aligned apertures (124a).

It will be appreciated that an elongate member may be inserted and retained through apertures (110a) of the hitch receiver member (110) and apertures (111a) of the first pair of adjustable arms (111) such that the first pair of adjustable arms (111) are rotatable relative to the hitch receiver member (110). Furthermore, an elongate member may be inserted and retained through apertures (111b) of the hitch receiver member (110) and apertures (124a) of the attachment member (120) such that the first pair of adjustable arms (111) are rotatable relative to the attachment member (120).

The first pair of adjustable arms (111) may be releasably connected to the attachment member (120) between at least a first position and a second position. This allows for the height of the attachment member (120) to be adjusted by moving the first pair of adjustable arms (111) relative to the attachment member (120).

The attachment member (120) may comprise an elongate member connected to an arcuate member. In one embodiment, the attachment member (120) comprises an arcuate portion (121) and an elongate portion (122). In an embodiment, the attachment member (120) is integrally formed. That is, the arcuate profile and elongate portion are integrally formed. The attachment member (120) may include a plurality of axially aligned pairs of apertures (123a, . . . n) for receiving a bolt or securing means therethrough to releasably secure the position of the attachment member (120) to the first pair of adjustable arms (111). The attachment member (120) may be adapted to align the axially aligned pairs of apertures (123a, . . . n) with a third pair of axially aligned apertures (111c) of the first adjustable arm (111) to allow a securing device to secure the attachment member in place.

The second pair of adjustable arms (112) may be connected at a second position to the hitch receiver member (110). The second pair of adjustable arms (112) may be fixedly rotationally or pivotably connected at a second position to the hitch receiver (110) member through a second pair of axially aligned apertures (110b). The second pair of adjustable arms (112) may be connected at a position to the attachment member (120). The second pair of adjustable arms (112) may be fixedly rotationally or pivotably connected at a position to the attachment member (120) through a second pair of axially aligned apertures (124b).

In an embodiment, the distance between the first pair of axially aligned apertures (110a) and the second pair of axially aligned apertures (110b) of the hitch receiver member (110) is the same as the distance between the first pair of axially aligned apertures (124a) and the second pair of axially aligned apertures (124b) of the attachment member (120). In use, the first pair of adjustable arms (111) and the second adjustable arms (112) remaining substantially or generally parallel to each other.

In this way, the adjustable hitch riser assembly (100) of the present invention provides a simple and effective means for adjusting the height of an attachment member (120) relative to a hitch receiver. The adjustable hitch riser assembly (100) is easy to use and allows for quick and easy adjustment of the height of the attachment member (120). The adjustable hitch riser assembly (110) is also durable and reliable, making it suitable for use in a variety of applications.

The height of the attachment member (120) can be adjusted by raising the vertical position thereof. As the attachment member (120) is lifted, the first pair of adjustable arms (111) and the second pair of adjustable arms (112) pivot or rotate at two points with the attachment portion (120) and/or the hitch receiver member (110). When the desired height is reached, a bolt or securing means is inserted into apertures (111c) and the appropriate axially aligned aperture (123a, . . . n) to retain the position thereof. It will be appreciated that, in use, the apertures (111c) are alignable with the axially aligned apertures (123a, . . . n). This allows for quick and easy adjustment of the height of the attachment member

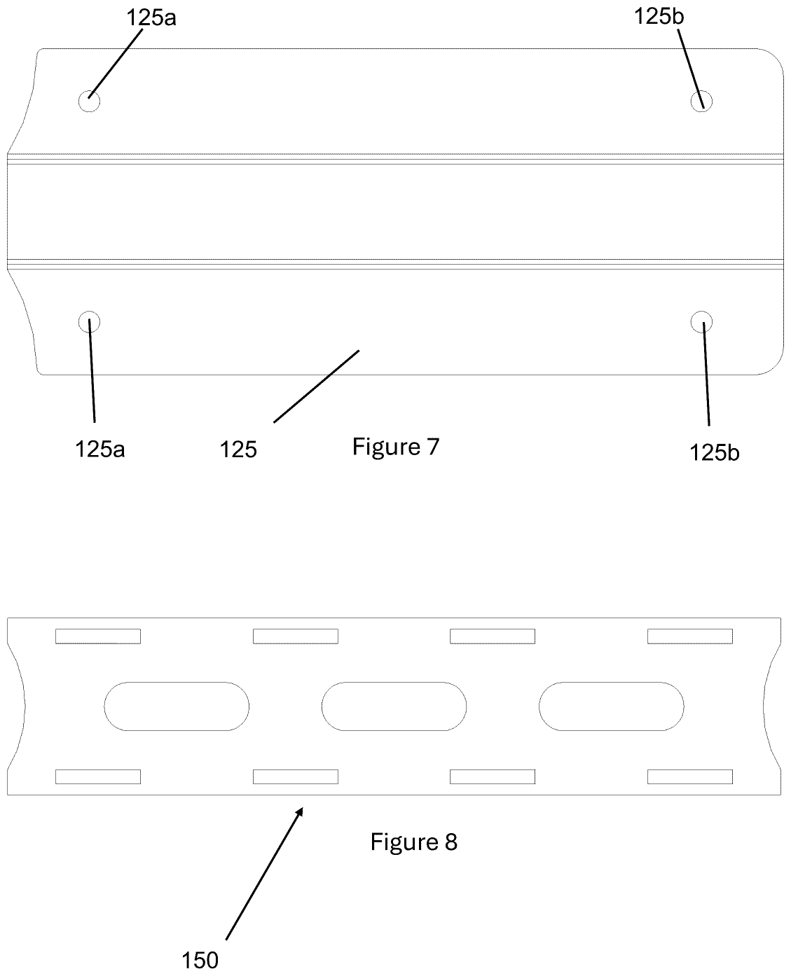

The attachment member (120) may further comprise a cover (125) adapted to assist in securing a platform or item. Shown in FIG. 7 is an embodiment of the cover (125) that can be folded or otherwise bent to conform around the elongate portion (121). The cover (125) may comprise a first pair of aligned apertures (125a) and a second pair of aligned apertures (125b). An elongate member may be inserted and retained in apertures (125b) of the cover (125) and apertures (124c) of the attachment member (120). A further elongate member may be inserted and retained into apertures (125a) of the cover (125). These elongate members suitably retain and secure the attachment member (120) to the cover (120). The attachment member (120) may further comprise a securing device or means for securing to the trailer. In one embodiment, the cover (125) is an adapter arm for providing easy connection to a number of purposes. In this regard, the cover (125) may be provided with attachment portions adapted to facilitate connection to the previously mentioned purposes.

In an embodiment, the hitch receiver member (110) may further comprise a member that is either received in a trailer tongue or receives a trailer tongue. In one embodiment, the hitch receiver member (110) further comprises a suitable sized and dimensioned member that is adapted to be received in a trailer tongue. In an embodiment, the hitch receiver member (110) further comprises a hitch receiver bar. In one embodiment, the hitch receiver member (110) further comprises a square tube (113).

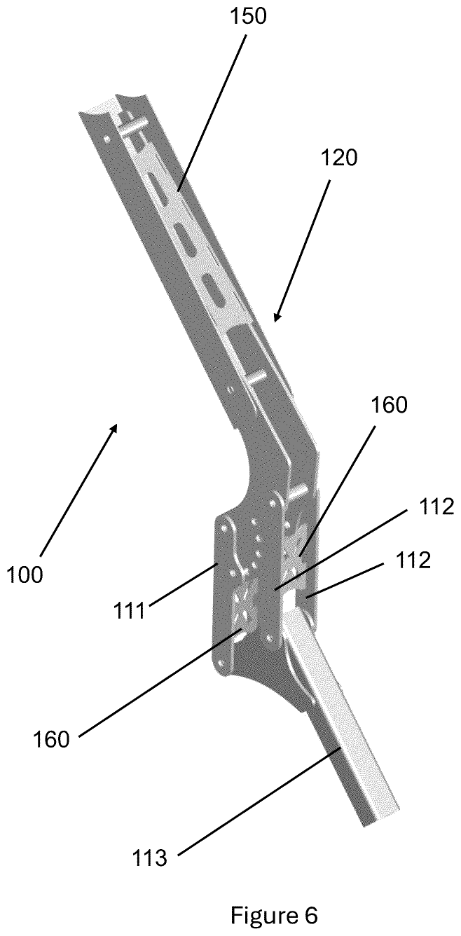

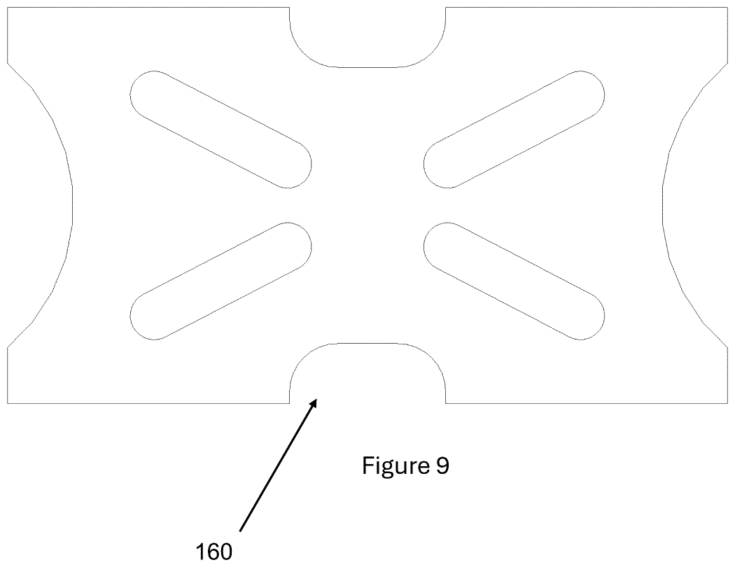

As shown in FIG. 6, the adjustable hitcher riser assembly may further comprise strengthening members. In this regard, FIG. 8 shows a strengthening member (150) that may be secured to the attachment member (120) to provide further strength and rigidity thereto. FIG. 9 shows another strengthening member (160) that may be secured to each pair of first arms (111) or each pair of second arms (112) to provide further strength and rigidity thereto.

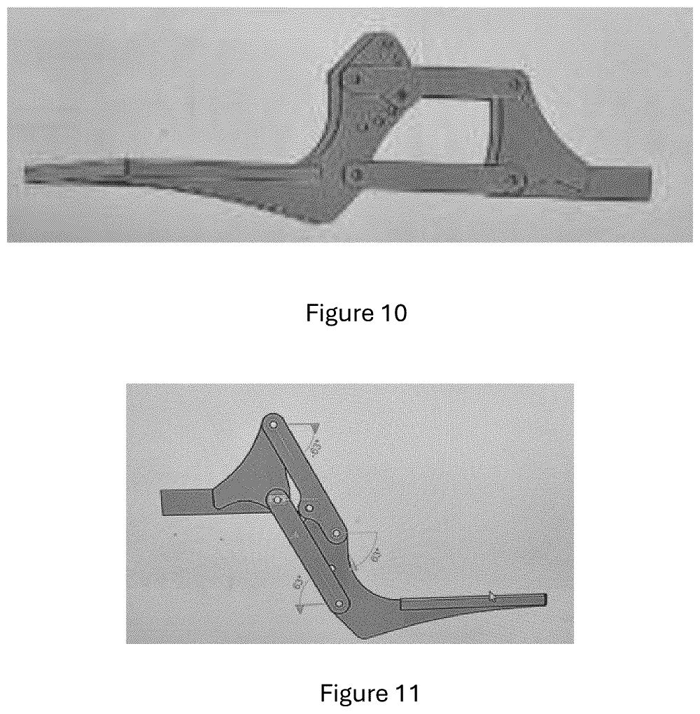

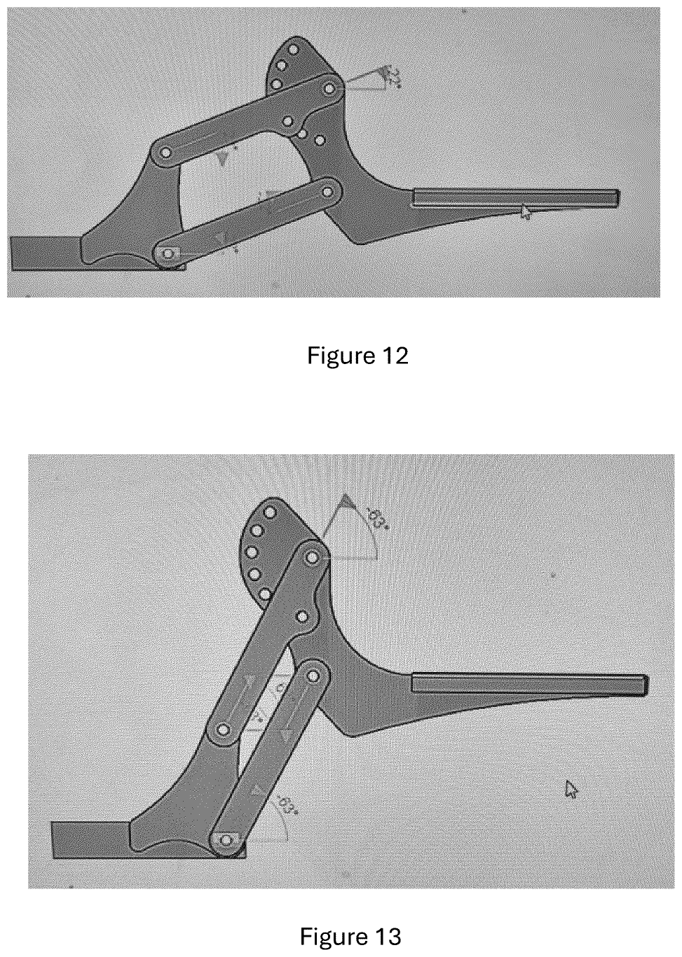

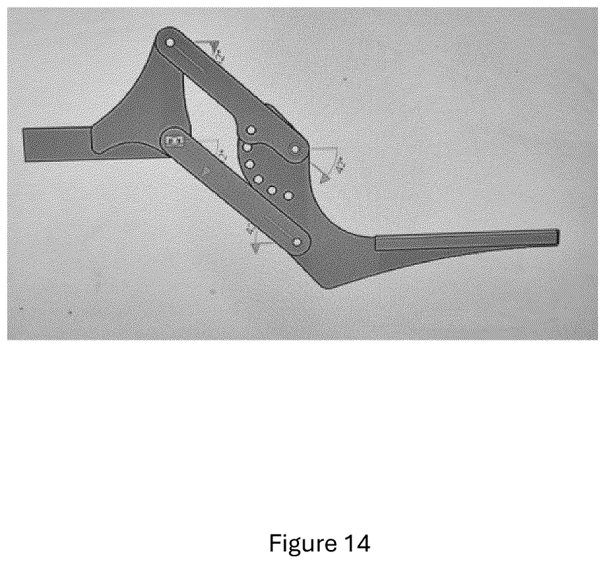

Shown in FIGS. 10 to 14 are different configurations of the adjustable hitch riser assembly. As shown in these figures, the attachment member may be height adjustable and retained in a number of vertical heights relative to the hitch receiver member. These figures show the apertures (111c) being aligned with the different apertures of the axially aligned apertures (123a, . . . n), and the resultant orientation of the attachment member (120) relative to the hitch receiver member (110).

Advantageously, the present invention also allows the hitch riser assembly to be folded away when not used. This provides a more space efficient hitch riser assembly. Furthermore, the present invention is easily attached and removed

Embodiments of the invention provide a hitch riser that is adjustable in height and adaptable for multiple attachments. Advantageously, it is envisioned that the hitch riser will avoid fatigue, cracking, bending or failure with adopted structural gusseting, CNC cut and fold and minimal welds.

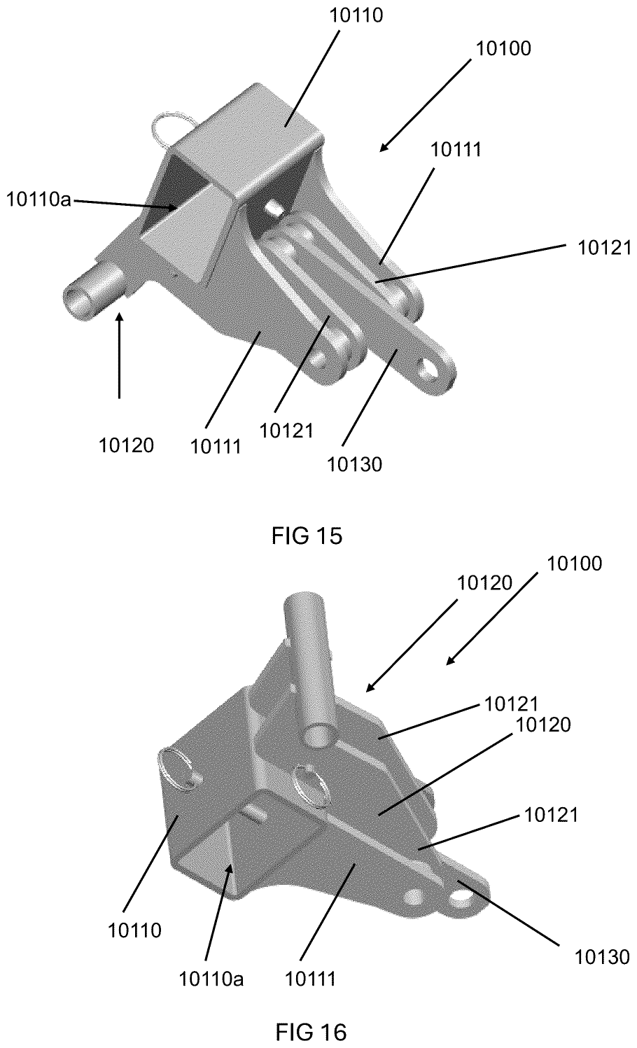

Shown in FIGS. 15 and 16 are an embodiment of a fastening system according to the present invention. The fastening system (10100) comprises a peg receiving member (10110) and a handle member (10120) pivotably or rotationally connected thereto. The peg receiving member (10110) comprises at least one first arm (10111). In an embodiment, the peg receiving member (10110) comprises a pair of first arms (10111). The handle member (10120) comprises at least one second arm (10121) pivotably or rotationally connected to the at least one first arm (10111). In one embodiment, the handle member (10120) comprises a pair of second arms (10121). In this regard, each of the pair of second arms (10121) is pivotable or rotationally connected to a respective first arm (10111). The fastening system (10100) further comprises a third member (10130) pivotably or rotationally connected to second arm (10121). The third member (10130) is adapted to releasably secure to a base or structure. In an embodiment, the fastening system (10100) comprises a single third member (10130).

The peg receiving member (10110) suitably comprises an aperture of bore (10110a) therein or therethrough to receive a peg of a bicycle. In an embodiment, the peg receiving portion (10110) comprises a body. In one embodiment, the body comprises the aperture or the bore (10110a). The body may comprise or is a tube. In an embodiment, the body may comprise or is suitably a square hollow section (SHS) or a rectangular hollow section (RHS). Preferably, the at least one first arm (10111) is connected or affixed to the body. In one embodiment, the first arm (10111) is welded to the body.

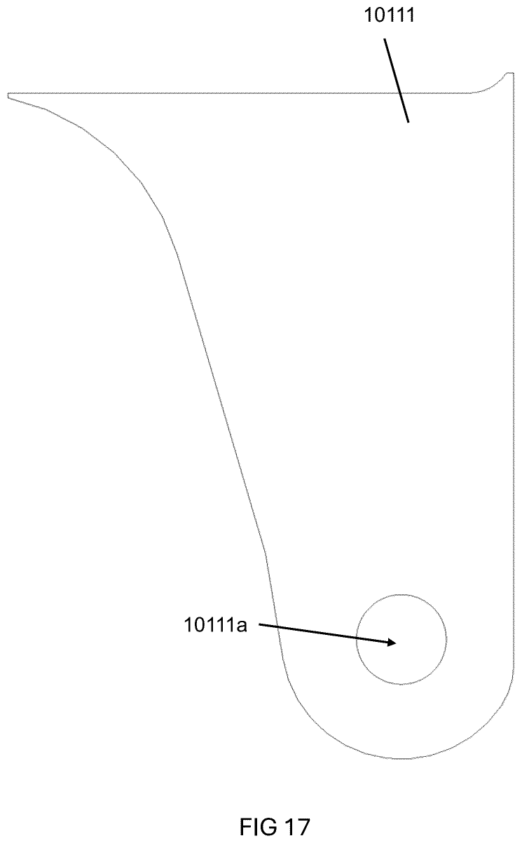

Shown in FIG. 17 is an embodiment of the first arm (10111). The first arm (10111) comprises an aperture (10111a) at a distal end thereof. In one embodiment, the first arm (10111) is suitably fin shaped. As mentioned above, the peg receiving member (10110) comprises a pair of first arms (10111). In one embodiment, the pair of first arms (10111) dependent from the same surface of the body. It will be appreciated that the pair of first arms are parallel, or substantially parallel, and aligned with one other. In one embodiment, the pair of first arms are spaced apart.

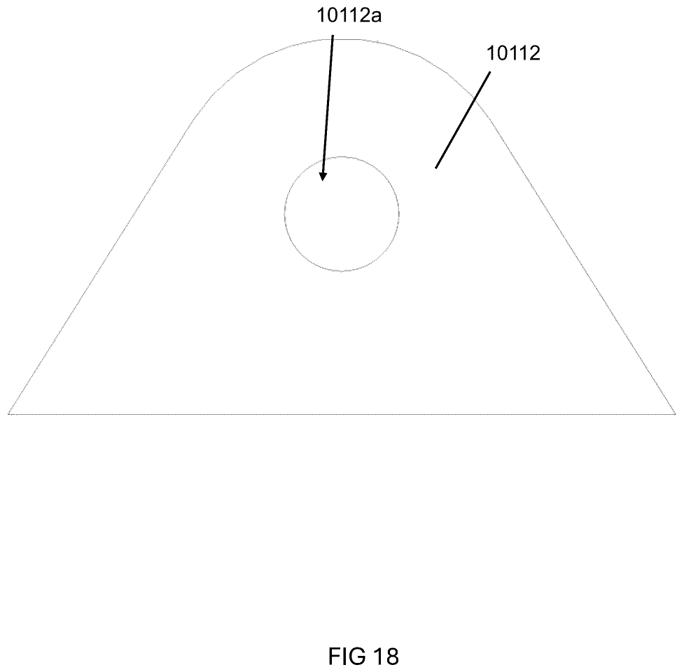

The peg receiving member (10110) may further comprises a securing tab (10112). The securing tab (10112) is shown in FIG. 18. The securing tab (10112) may be connected or affixed to the body. In one embodiment, the securing tab (10112) is welded to the body. The securing tab (10112) comprises an aperture (10112a).

The body may suitably comprise a pair of aligned apertures therethrough (shown with a securing device therein in FIG. 15 and FIG. 16). The pair of aligned apertures are sized and aligned to retain a pin therethrough. In use, a peg is suitably placed into the aperture or bore of the body, and a pin is inserted through the aligned apertures to ensure that the bicycle (via the peg) is securely retained therewith. In one embodiment, the peg receiving member (10110) is integrally formed.

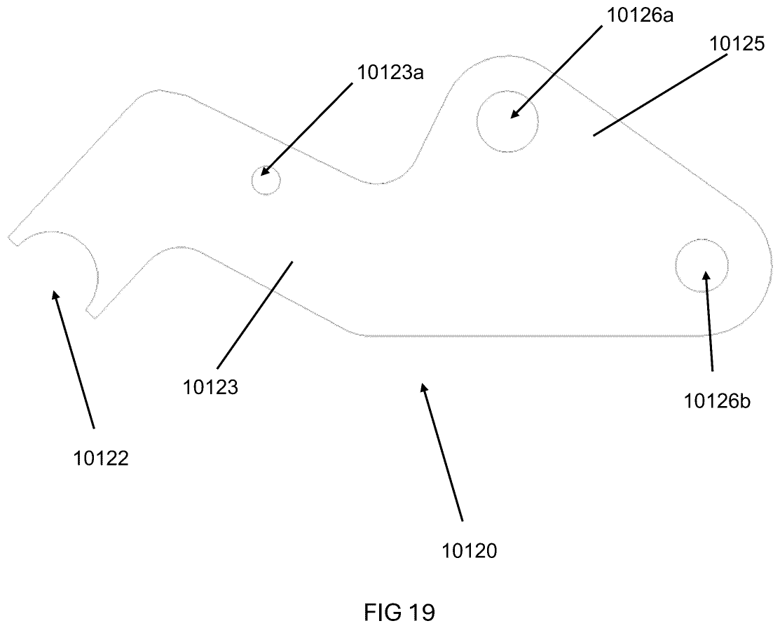

Shown in FIG. 19 is an embodiment of a portion of the handle member (10120). The handle member (10120) comprises a handle (not shown, but reference 10122 shows where the handle should be) connected to a pivotably section (10125). The pivotable section (10125) comprises or is the second arm (10121). The second arm (10121) comprises a first aperture (10126a) spaced apart from a second aperture (10126b). In an embodiment, the second aperture (10126b) is adapted to connect to the first arm (10111). In an embodiment, the first aperture (10126a) is adapted to connect to the third member (10130).

The handle (10122) is suitably connected to the pivotable section (10125) by an elongate portion (10123). The elongate portion (10123) suitably comprises an aperture (10123a) adapted to releasably secure to the peg receiving member (10110). In this regard, the aperture (10123a) is alignable with aperture (10112a) to receive a bolt, securing device or pin therethrough to retain the orientation thereof. As shown, the elongate portion (10123) extends substantially parallel to the longitudinal axis of the pivotable section. As shown, the handle is connected to the elongate portion away from the pivotable section.

It will be appreciated that the handle (10122) is suitably an elongate member that is connected to a pair of elongate members (10123) and the pivotable section (125) associated with each of the pair of elongate members (10123).

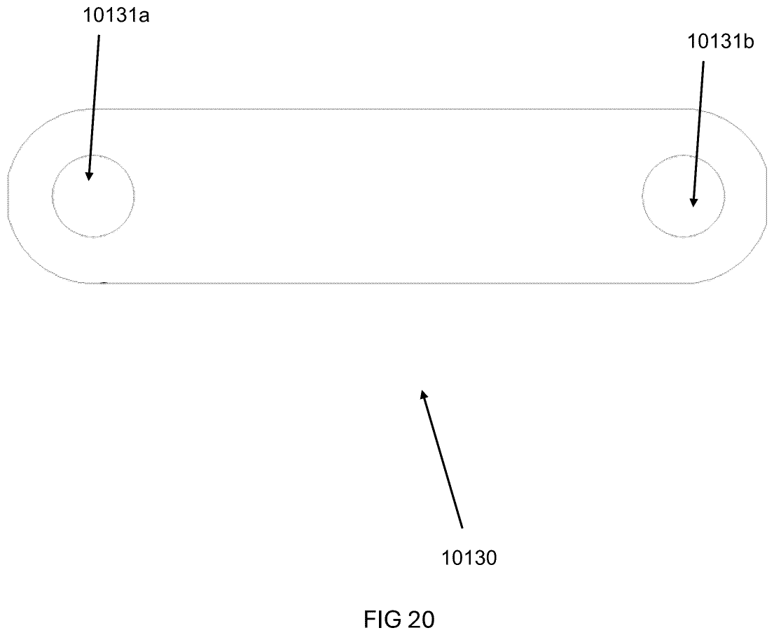

Shown in FIG. 20 is an embodiment of the third member (10130). The third member (10130) comprise a first aperture (10131a) that is spaced apart from a second aperture (10131b). The first aperture (10131a) is located at a first end or adjacent thereof of the third member (10131). The second aperture (10131b) is located at an opposing end or adjacent thereof of the third member (10131). The second aperture (10131b) may be secured to a base or structure.

It will be appreciated that an elongate member (such as a bolt or the like) may be inserted and retained through apertures (10111a) of the first arm (10111) and the apertures (10126b) of the handle member (10120). This allows for the handle member (10120) to be pivotably or rotationally connected to the peg receiving member (10110).

An elongate member may also be inserted and retained through apertures (10126a) of the handle member (10120) and first apertures (10131a) of the third member (10130). This allows for the handle member (10120) to be pivotably or rotationally connected to the third member (10130).

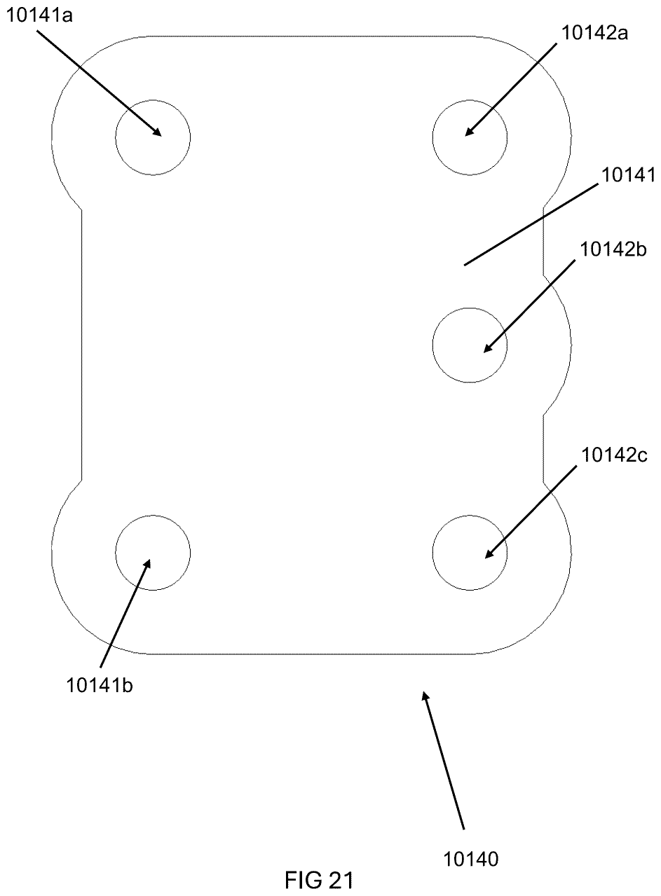

Shown in FIG. 21 is an embodiment of the base or structure (10140). The base (10140) suitably comprises a plate (10141). The plate (10141) suitably comprises a plurality of apertures. One set of apertures (10141a, 10142b) is adapted to fasten the plate to a desired surface. Another set of apertures (10142a, 10142b, 10142c) are adapted to receive a fastener or the like to connect to the second aperture (10131b) of the third member (10131) thereto. The multiple apertures allows for the location of the bicycle relative to the base to be varied. In one embodiment, a set of chain links or chain is utilized to connect the base (10140) to the third member (10130). However, it will be appreciated by the person skilled in the art that other types of links can be utilized to connect the third member to the base or structure. In one embodiment, the structure is suitably a tray or a trailer bed.

It will be appreciated that the fastening system is suitably a tie down system. In use, the fastening system is suitably secured or fastened to a secure base. Alternatively, a device similar to the abovementioned base can be secured to a surface and the third member is connected thereto by a fastener.

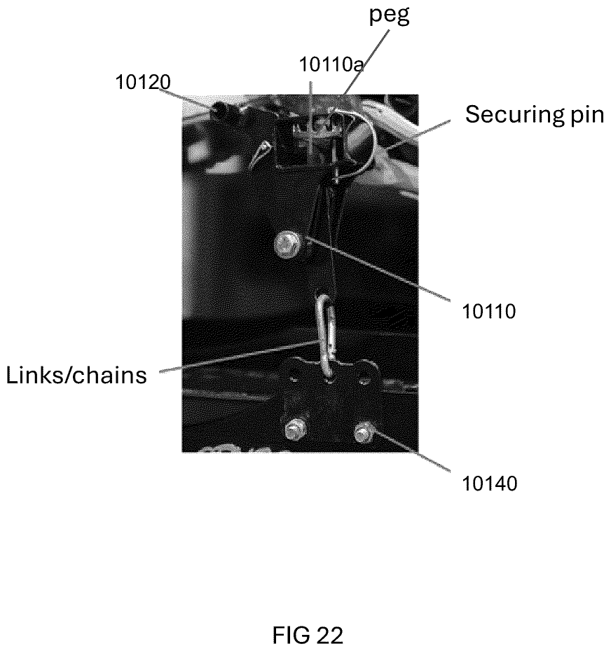

Shown in FIG. 22 is an embodiment of the present fastening system being utilized to secure a bicycle. A bicycle can be placed above the fastening system and the peg thereof is inserted into the aperture of the peg receiving member. Once located, a securing pin can be utilized to retain the position of the peg in the peg receiving member. The handle of the handle member is then pulled up. This pulling action leads to the pivotable section to pivot upwardly and this causes the third member attached thereto to also move upwardly. This causes a pulling force on the bicycle as the third member is connected to a stable structure or base. The action of pulling up the handle causes the bicycle to be pulled down and thus retained. Once the handle member is pulled up sufficiently such that the aperture thereof aligns with the aperture of the tab then a securing pin can be inserted therein to retain the position.

It will be appreciated that as the handle member is pulled up, the total length of the fastening system is lowered and thus applies a pressure on the peg. This applies a downward pressure on the bicycle such that it is held in place. In use, as the handle member is pulled, this causes the first aperture thereof to be pulled in between the pair of first arms and closer to the body. This then causes the third member which is pivotably connected to the first aperture to also be pulled up. This simple action of pulling the handle member results in compressive pressure being applied to the peg of the bicycle. This compressive pressure is maintained by inserting a securing device, pin or the like through the apertures to maintain the orientation of the handle member relative to the peg receiving member. In one embodiment, the fastening system is configured to be in an extended position or a retracted/storing position. In the extended position, the distance between the body and the third arm is greater than the distance between the body and the third arm in stored position.

The present fastening system provides a durable, structurally engineered system that does not unwind or rattle loose. Furthermore, the single motion of pulling the handle provides a simple and effective strategy for retaining a bicycle. The present fastening system is also able to be adapted to different bicycle heights by simply adjusting the chain length. The present fastening system eliminates the requirement for straps, wheel chocks or shock absorbers and this provides less fatigue on the bicycle. Advantageously, it is envisioned that the present fastening system will avoid fatigue, cracking, bending or failure with adopted structural gusseting, CNC cut and fold and minimal welds. The present invention alleviates the problems mentioned hereinabove.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A fastening system comprising:
a peg receiving member having at least one first arm;
a handle member pivotably or rotationally connected to the peg receiving member, the handle member comprising at least one second arm pivotably or rotationally connected to the at least one first arm; and
a third member pivotably or rotational connected to the second arm, wherein the third arm is adapted to releasably secure to a base.

2. The fastening system of claim 1, wherein the peg receiving member comprises a body comprising an aperture or bore therethrough for receiving a peg of a bicycle.

3. The fastening system of claim 2, wherein the body is or comprises a square hollow section or a rectangular hollow section.

4. The fastening system of claim 2, wherein at least one first arm is affixed and/or secured to the body.

5. The fastening system of claim 1, wherein the peg receiving member comprises a pair of first arms that are spaced apart.

6. The fastening system of claim 5, wherein each first arm comprises an aperture at a distal end thereof.

7. The fastening system of claim 1, wherein the peg receiving member further comprises a securing tab having an aperture.

8. The fastening system of claim 2, wherein the body comprises a pair of aligned apertures adapted to retain a securing device therethrough.

9. The fastening system of claim 1, wherein the handle member comprises a pivotable section.

10. The fastening system of claim 9, wherein the pivotable section comprises or is the second arm.

11. The fastening system of claim 10, wherein the second arm comprises a first aperture spaced apart from a second aperture.

12. The fastening system of claim 11, wherein the first aperture is adapted to pivotably or rotationally connected to the third member.

13. The fastening system of claim 11, wherein the second aperture is adapted to pivotably or rotational connect to a respective first arm.

14. The fastening system of claim 9, wherein a handle is connected to the pivotable section by an elongate portion.

15. The fastening system of claim 14, wherein the elongate portion comprises an aperture adapted to receive a securing device, wherein the aperture of the elongate portion is alignable with the aperture of the securing tab.

16. The fastening system of claim 1, wherein the third member comprises a first aperture that is spaced apart from the third aperture.

17. The fastening system of claim 1, further comprising a base having a plate comprising a first set of apertures adapted to fasten to a desired surface, wherein the plate comprises a second set of apertures adapted to receive a fastener or link to connect to the second aperture of the third member.

18. The fastening system of claim 16, further comprising a length of chain connecting the base to the third member.

19. The fastening system of claim 1, further comprising a first securing device adapted to secure the peg to the peg receiving member.

20. The fastening system of claim 1, further comprising a second securing device adapted to retain the orientation of the handle member to the peg receiving portion.
